(19) United States
(12) Patent Application Publication
(10) Pub. No.: US 2025/0172737 A1
(43) Pub. Date: May 29, 2025

(54) BACKLIGHT MODULE

(71) Applicant: DARWIN PRECISIONS CORPORATION, Hsinchu County (TW)

(72) Inventor: YU-HUAN CHIU, Hsinchu County (TW)

(21) Appl. No.: 18/923,720

(22) Filed: Oct. 23, 2024

(30) Foreign Application Priority Data
Nov. 24, 2023 (TW) 112145609

(51) Int. Cl. F21V 8/00

(52) U.S. Cl. CPC G02B 6/005; G02B 6/0036; G02B 6/0043; G02B 6/0068; G02B 6/0076

(57) ABSTRACT

A backlight module includes a light guide assembly, a first light source, a second light guide plate, a second light source, and a turning film. The light guide assembly includes a plurality of overlapped first light guide plates. Each first light guide plate has a first bottom surface, a first light-emitting surface, and a first light-incident surface. The first bottom surface has first microstructures. The first light source is arranged next to first light-incident surfaces of the first light guide plates. The second light guide plate is arranged above the light guide assembly and has a second bottom surface, a second light-emitting surface, and a second light-incident surface. The second bottom surface has second microstructures. The second light source is arranged next to the second light-incident surface of the second light guide plate. The turning film is arranged between the light guide assembly and the second light guide plate.

### FIELD OF THE INVENTION

The present invention relates to a backlight module, and particularly relates to a backlight module capable of switching modes.

### BACKGROUND OF THE INVENTION

At present, most liquid crystal display devices have a wide-viewing-angle display effect. However, on certain occasions, there may be a requirement to prevent displayed content from being seen by others. Therefore, a function of switching between a sharing mode and an anti-peeping mode is developed. Known liquid crystal display devices mainly achieve an anti-peeping effect by arranging an anti-peeping sheet in a backlight module, which, on the contrary, will decrease the brightness of the backlight module. To maintain the original brightness in the case that there is an anti-peeping sheet, it is needed to increase the power of a light source, which further results in an increase in the cost of the backlight module and the increased thickness of an overall structure.

### SUMMARY OF THE INVENTION

The present invention provides a backlight module, which can improve the light utilization ratio.

A backlight module provided by the present invention includes a light guide assembly, a first light source, a second light guide plate, a second light source, and a turning film. The light guide assembly includes a plurality of overlapped first light guide plates, where each of the first light guide plates has a first bottom surface and a first light-emitting surface opposite to each other, and a first light-incident surface connecting the first bottom surface to the first light-emitting surface. The first bottom surface is provided with a plurality of first microstructures. The first light source is arranged next to a plurality of first light-incident surfaces of the plurality of first light guide plates. The second light guide plate is arranged above the light guide assembly. The second light guide plate has a second bottom surface and a second light-emitting surface opposite to each other, and a second light-incident surface connecting the second bottom surface to the second light-emitting surface, and the second bottom surface faces the light guide assembly and is provided with a plurality of second microstructures. The second light source is arranged next to the second light-incident surface of the second light guide plate. The turning film is arranged between the light guide assembly and the second light guide plate.

In an embodiment of the present invention, the backlight module further includes an anti-peeping sheet, arranged between the second light guide plate and the turning film.

In an embodiment of the present invention, the backlight module further includes a reflective sheet, arranged on a side, away from the second light guide plate, of the light guide assembly.

In an embodiment of the present invention, the plurality of first microstructures are prisms and are arranged in multiple rows; a row direction of the rows is perpendicular to the first light-incident surface; an extension direction of each of the first microstructures is perpendicular to the row direction; and there is a plurality of first microstructures in each of the rows.

In an embodiment of the present invention, there is an included angle between the first light-incident surface and the second light-incident surface.

In an embodiment of the present invention, the first light-emitting surface and the second light-emitting surface of each of the first light guide plates are rectangular, the first light source faces a long edge of the first light-emitting surface of each of the first light guide plates, and the second light source faces a short edge of the second light-emitting surface.

In an embodiment of the present invention, a thickness of each of the first light guide plates is less than a thickness of the second light guide plate.

In an embodiment of the present invention, the plurality of second microstructures are micro-dot structures protruding out of or sunken into the second bottom surface.

In an embodiment of the present invention, the first light source includes a plurality of first light-emitting elements; the second light source includes a plurality of second light-emitting elements; each of the first light-emitting elements has a first length in a predetermined direction perpendicular to the first light-emitting surface; the light guide assembly has a second length in the predetermined direction; and the second length is greater than the first length.

In an embodiment of the present invention, the first bottom surface of each of the first light guide plates has a central area and a peripheral banded area; the peripheral banded area at least partially encircles the central area; the central area has the plurality of first microstructures; the peripheral banded area has a plurality of third microstructures; and the third microstructures are different from the first microstructures.

The light guide assembly of the backlight module provided by the present invention uses a plurality of overlapped first light guide plates. The first light guide plates are thinner, which contributes to transmitting light rays in the first light guide plates to the first microstructures, so that the light rays are easily emitted from the first light-emitting surface, and therefore, the light utilization ratio can be improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a three-dimensional schematic diagram of a backlight module in an embodiment of the present invention;

FIG. 2 is a partially three-dimensional schematic diagram of a first light guide plate in the backlight module in an embodiment of the present invention;

FIG. 3A is a schematic diagram of a light ray transmission path of the backlight module in an anti-peeping mode in an embodiment of the present invention;

FIG. 3B is a schematic diagram of the light ray transmission path of the backlight module in a sharing mode in an embodiment of the present invention;

FIG. 4 is a schematic diagram of the brightness distributions of the backlight module in the sharing mode and the anti-peeping mode in an embodiment of the present invention;

FIG. 5 is a schematic bottom diagram of a first light guide plate of a backlight module in another embodiment of the present invention; and

FIG. 6 is a cross-sectional diagram taken along the section C-C in FIG. 5.

### DETAILED DESCRIPTION OF PREFERRED EMBODIMENTS

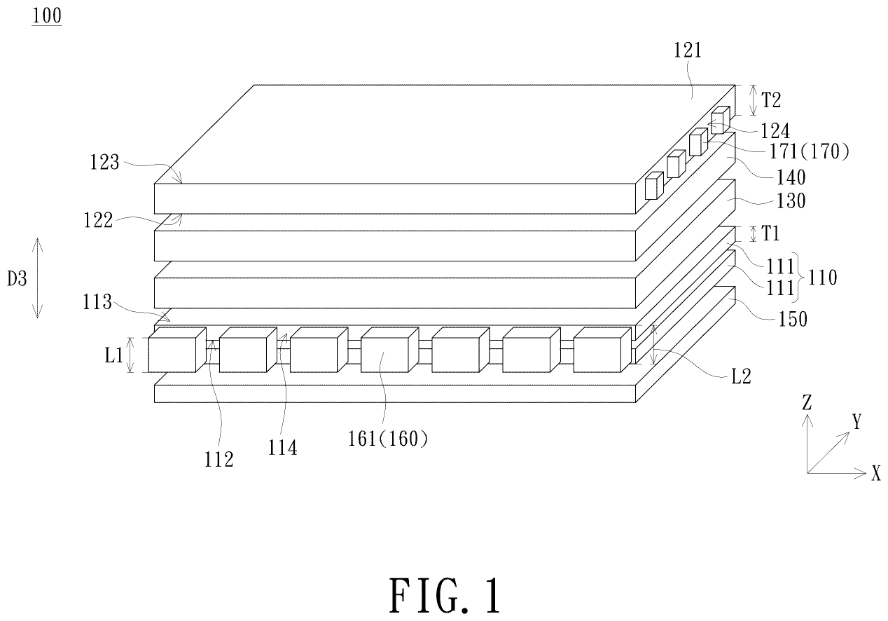

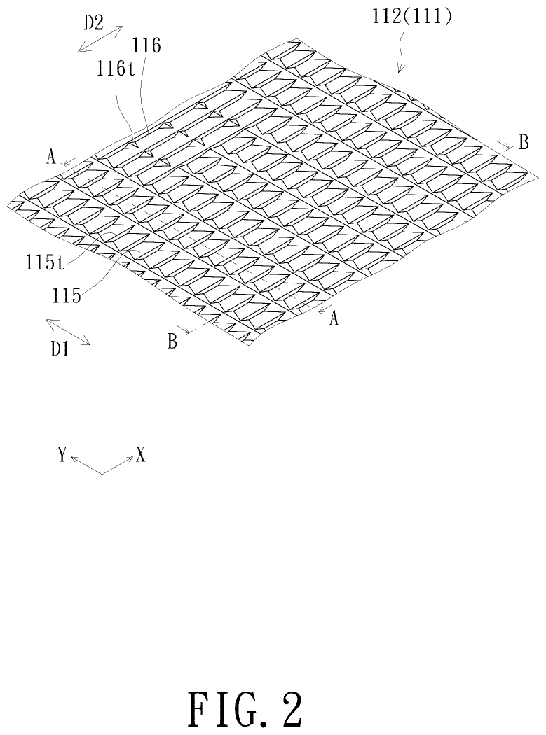

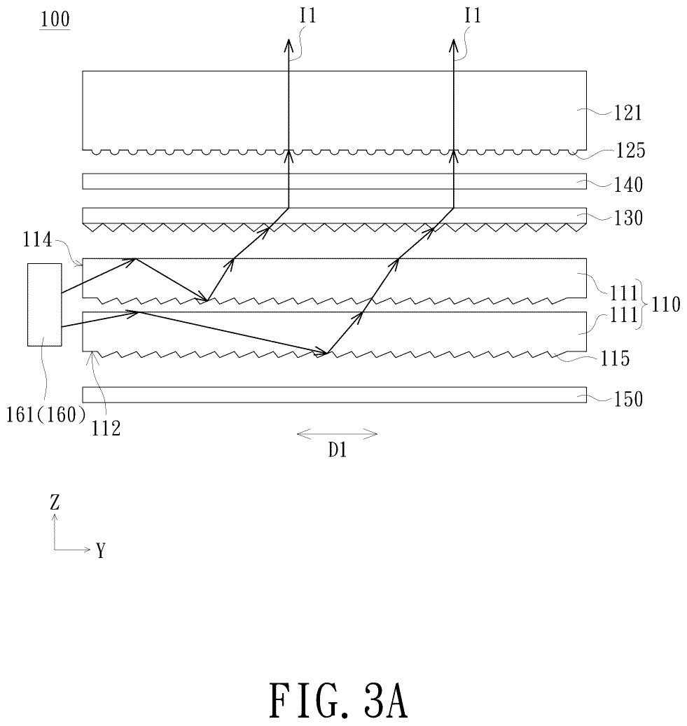

FIG. 1 is a three-dimensional schematic diagram of a backlight module in an embodiment of the present invention. FIG. 2 is a partially three-dimensional schematic diagram of a first light guide plate in the backlight module in an embodiment of the present invention, wherein FIG. 2 is shown with the first bottom surface facing upward. FIG. 3A is a schematic diagram of a light ray transmission path of the backlight module in an anti-peeping mode in an embodiment of the present invention. FIG. 3B is a schematic diagram of a light ray transmission path of the backlight module in a sharing mode in an embodiment of the present invention. It is to be noted that FIG. 3A is a cross-sectional diagram taken along the section A-A in FIG. 2, wherein the section A-A is, for example, parallel to a row direction D1. FIG. 3B is a cross-sectional diagram taken along the section B-B in FIG. 2, wherein the section B-B is, for example, parallel to an extension direction D2.

Referring to FIG. 1, FIG. 3A, and FIG. 3B first, a backlight module 100 in the embodiment includes a light guide assembly 110, a first light source 160, a second light guide plate 121, a second light source 170, a turning film 130, and a reflective sheet 150. The light guide assembly 110 in the embodiment includes a plurality of overlapped first light guide plates 111, where each of the first light guide plates 111 has a first bottom surface 112 and a first light-emitting surface 113 opposite to each other, and a first light-incident surface 114 connecting the first bottom surface 112 to the first light-emitting surface 113. The first bottom surface 112 is provided with a plurality of first microstructures 115. The first light source 160 is arranged next to a plurality of first light-incident surfaces 114 of the plurality of first light guide plates 111. The second light guide plate 121 is arranged above the light guide assembly 110. The second light guide plate 121 has a second bottom surface 122 and a second light-emitting surface 123 opposite to each other, and a second light-incident surface 124 connecting the second bottom surface 122 to the second light-emitting surface 123. The second bottom surface 122 faces the light guide assembly 110 and is provided with a plurality of second microstructures 125. The second light source 170 is arranged next to the second light-incident surface 124 of the second light guide plate 121. The turning film 130 in the embodiment is arranged between the light guide assembly 110 and the second light guide plate 121. The reflective sheet 150 is arranged on a side, away from the second light guide plate 121, of the light guide assembly 110. The arrangement of the reflective sheet 150 contributes to reflecting a first light ray I1 (not shown in the figures) emitted from the first bottom surface 112 back to the first light guide plate 111, so as to improve the light utilization ratio.

Specifically, the first light-emitting surface 113 and the second light-emitting surface 123 are, for example, rectangular. The first light source 160 is, for example, arranged next to a long edge of the first light-emitting surface 113. The second light source 170 is, for example, arranged next to a short edge of the second light-emitting surface 123. The first light source 160 matches with the light guide assembly 110 so that the first light ray I1 provided by the first light source 160 becomes a surface light source. The second light source 170 matches with the second light guide plate 121 so that a second light ray 12 provided by the second light source 170 becomes a surface light source. The turning film 130 in the embodiment is, for example, an inverse prism, arranged between the light guide assembly 110 and the second light guide plate 121. In the embodiment, a light-emitting angle of the first light ray I1 emitted from the light guide assembly 110 is decreased by arranging the turning film 130, so that the brightness is improved. The backlight module 100 in the embodiment further includes an anti-peeping sheet 140, arranged between the second light guide plate 121 and the turning film 130. The anti-peeping film 140 is used, for example, to ensure that the first light ray I1 can only exit within a certain viewing angle range after passing through the anti-peeping film 140, such as within a viewing angle range close to the front view. In other words, after the viewing angle of the first light ray I1 is converged by the turning film 130, the viewing angle can further be secondarily converged by the anti-peeping sheet 140. Therefore, as shown in FIG. 3A, when only the first light source 160 is turned on, the display light source provided by the backlight module 100 is a surface light source formed by the first light ray I1, and in this case, the backlight module 100 is in an anti-peeping mode, but the present invention is not limited thereto. In another embodiment, the backlight module 100 may not include the anti-peeping sheet 140.

On the other hand, as shown in FIG. 3B, when both the first light source 160 and the second light source 170 are turned on, the backlight module 100 is in a sharing mode. In a sharing mode, the display light source provided by the backlight module 100 includes not only the surface light source formed by the first light ray I1 but also the surface light source formed by the second light ray 12. Because the second light ray 12 does not pass through the turning film 130, the surface light source formed by the second light ray 12 has a relatively large light-emitting angle.

Continuously referring to FIG. 1 and FIG. 3A, compared with adopting a conventional single light guide plate with a large thickness, the first light guide plate 111 of the light guide assembly 110 is thinner, and therefore the path where the first light ray I1 is reflected to the first bottom surface 112 is shortened, which contributes to transmitting the first light ray I1 in the first light guide plate 111 to the first microstructures 115 so that the first light ray I1 is easily emitted from the first light-emitting surface 113. Thus, it contributes to increasing the light-emitting efficiency of the first light ray I1 emitted from the light guide assembly 110; that is, the light utilization ratio is improved.

In addition, the thickness T1 of each of the first light guide plates 111 is, for example, less than the thickness T2 of the second light guide plate 121. Specifically, the thickness T1 of each of the first light guide plates 111 is, for example, the same, and the thickness T1 is, for example, ½ of the thickness T2. For example, in the embodiment, the thickness T1 of the first light guide plate 111 is between 0.5 mm and 1 mm, for example, 0.7 mm, and the thickness T2 of the second light guide plate 121 is between 1.5 mm and 2 mm, but the present invention is not limited thereto.

Referring to FIG. 1, the first light source 160 in the embodiment includes, for example, a plurality of first light-emitting elements 161. The second light source 170 includes, for example, a plurality of second light-emitting elements 171. The first light-emitting elements 161 and the second light-emitting elements 171 are, for example, light-emitting diodes, but the present invention is not limited thereto. Each of the first light-emitting elements 161 in the embodiment has, for example, a first length L1 in a predetermined direction D3 perpendicular to the first light-emitting surface 113. The light guide assembly 110 has, for example, a second length L2, in the predetermined direction D3. The second length L2 is, for example, greater than the first length L1. Specifically, because the area of the first light-incident surface 114 of the first light guide plate 111 is decreased with the decreasing of the thickness T1, the first light ray I1 provided by the first light source 160 can enter the first light-incident surfaces 114 of the first light guide plates 111 by way of overlapping the plurality of first light guide plates 111, so that the light utilization ratio is improved. In other words, when the quantity of the first light guide plates 111 is increased so that the second length L2 of the light guide assembly 110 in the predetermined direction D3 is, for example, greater than the first length L1, more first light rays I1 can be effectively utilized. In another embodiment, the first length L1 can be equal to the second length L2. There are, for example, two first light guide plates 111 in the light guide assembly 110 in the embodiment, but the present invention has no specific limitations on the quantity of the first light guide plates 111. In addition, for example, there is a 0.05 mm spacing between the first light guide plates 111, but the present invention has no specific limitations thereon.

Referring to FIG. 1 and FIG. 2 continuously, the plurality of first microstructures 115 in the embodiment are, for example, prisms and are arranged in a plurality of rows. The row direction D1 of the plurality of rows is, for example, perpendicular to the first light-incident surface 114. The extension direction D2 of each of the first microstructures 115 is, for example, perpendicular to the row direction D1. There are, for example, a plurality of first microstructures 115 in each of the rows. Specifically, each of the first microstructures 115 in the embodiment has, for example, a ridge 115t, which extends, for example, in the extension direction D2. In the embodiment, the row direction D1 is, for example, parallel to the second direction Y, the extension direction D2 is, for example, parallel to the first direction X, the row direction D1 is, for example, perpendicular to the extension direction D2, but the present invention is not limited thereto. In other embodiments of the present invention, an included angle between the row direction D1 and the extension direction D2 may have another angle degree. The first microstructure 115 in the embodiment protrudes, for example, from the first bottom surface 112, but the present invention is not limited thereto.

Continuously referring to FIG. 2, the first bottom surface 112 in the embodiment is, for example, further provided with a plurality of fourth microstructures 116, and each of the fourth microstructures 116 is, for example, connected to two adjacent first microstructures 115. Each of the fourth microstructures 116 has, for example, a long axis 116t, and the plurality of long axes 116t of the plurality of fourth microstructures 116 extend, for example, in the row direction D1. The plurality of fourth microstructures 116 in the embodiment are, for example, arranged in a plurality rows in the row direction D1, and there are, for example, a plurality of fourth microstructures 116 in each of the rows. The fourth microstructures 116 in each of the rows in the embodiment can be connected or not connected. The shapes or heights of the plurality of fourth microstructures 116 can be different according to the positions thereof on the first light guide plate 111. For example, in the embodiment, the height of the fourth microstructure 116 increases or decreases progressively in the row direction D1, but the present invention is not limited thereto. The fourth microstructure 116 in the embodiment protrudes, for example, from the first bottom surface 112, but the present invention is not limited thereto. The first microstructure 115 and the fourth microstructure 116 in the embodiment are, for example, integrally formed with the first light guide plate 111.

Refer to FIG. 1, FIG. 2, and FIG. 3A together. Because of the first microstructure 115 on the first bottom surface 112, the backlight module 100 in the embodiment can effectively control the light-emitting angle of the first light ray I1 emitted from the first light-emitting surface 113. In addition, the plurality of fourth microstructures 116 is further distributed among the plurality of first microstructures 115, so the uniformity of the surface light source provided by the first light-emitting surface 113 can be further increased, which can avoid the occurrence of patterns corresponding to the first microstructures 115 in the local areas of the backlight module 100.

Referring to FIG. 3B, the plurality of second microstructures 125 in the embodiment are, for example, micro-dot structures protruding from or sunken into the second bottom surface 122. Specifically, the plurality of second microstructures 125 in the embodiment is, for example, randomly distributed on the second bottom surface 122 to increase the uniformity of the surface light source provided by the second light source 170. The plurality of second microstructures 125 in the embodiment is, for example, protruding from the second bottom surface 122. It is to be noted that residues may be generated when a similar microstructure is manufactured in the prior art, which affects the quality of the surface light source (e.g., stray light may be generated). Therefore, in the embodiment, a metal-isolated layer (not shown in the figures) is, for example, formed first on the second bottom surface 122 when the plurality of second microstructures 125 are manufactured, so that the residues generated in the process of processing and forming the plurality of second microstructures 125 are accumulated in the metal-isolated layer without being adhered to the second bottom surface 122. Therefore, the second bottom surface 122 without the residues can be formed after the metal-isolated layer is removed, which contributes to increasing the uniformity of the surface light emitted from the second light-emitting surface 123.

In the embodiment, by arranging the plurality of second microstructures 125 protruding from or sunken into the second bottom surface 122, the second light source 170 of the backlight module 100 can provide a more uniform surface light source. In addition, when the first light ray I1 can pass through the second bottom surface 122, the transmission path will not be affected by the residues.

Referring to FIG. 1, in the embodiment, there is, for example, an included angle between the first light-incident surface 114 and the second light-incident surface 124. In other words, the first light-incident surface 114 and the second light-incident surface 124 are not in a parallel plane. Specifically, the first light-emitting surface 113 and the second light-emitting surface 123 of each of the first light guide plates 111 in the embodiment are, for example, rectangular. The first light source 160 faces, for example, a long edge of the first light-emitting surface 113 of each of the first light guide plates 111, and the second light source 170 faces, for example, a short edge of the second light-emitting surface 123. In other words, the first light-incident surface 114 is, for example, a plane formed in parallel to the first direction X and a third direction Z. The second light-incident surface 124 is, for example, a plane formed parallel to the first direction X and the second direction Y. The included angle between the first light-incident surface 114 and the second light-incident surface 124 is, for example, 90 degrees, but the present invention is not limited thereto. In another embodiment of the present invention, the included angle between the first light-incident surface 114 and the second light-incident surface 124 has, for example, another angle degree. In addition, the present invention also has no specific limitations on the position of the first light source 160 facing the first light-emitting surface 113 or the position of the second light source 170 facing the second light-emitting surface 123.

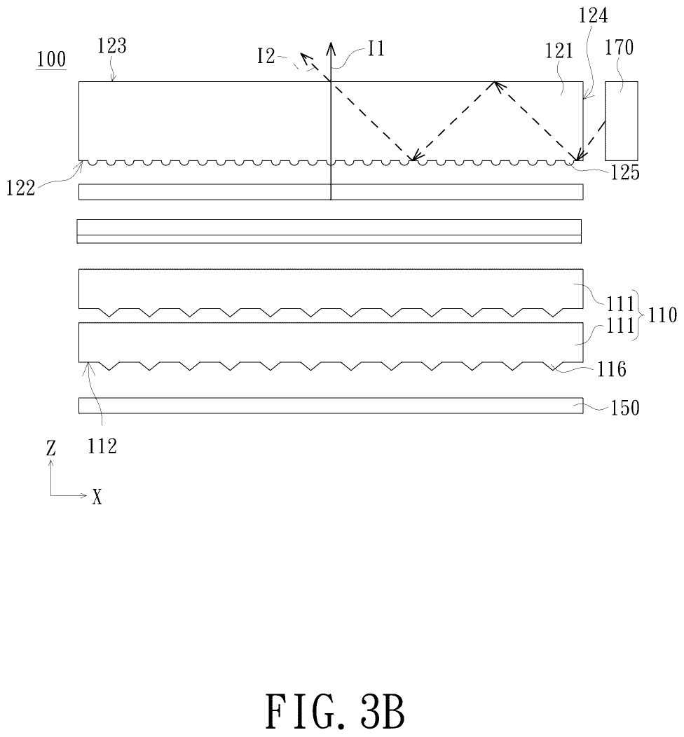

FIG. 4 is a schematic diagram of the brightness distributions of the backlight module in the sharing mode and the anti-peeping mode in an embodiment of the present invention. Referring to FIGS. 1-4, the main brightness of the backlight module 100 in the embodiment in the anti-peeping mode is distributed between +30 degrees and −30 degrees of the viewing angle. In the sharing mode, the brightness is greatly improved when the viewing angle is between 0 degrees and −80 degrees.

Referring to FIG. 3A, FIG. 3B, and FIG. 4, the backlight module 100 in the embodiment can be applied to a vehicle display device. Specifically, the second light source 170 is, for example, arranged on the right side when the vehicle is left-hand drive and the above vehicle display device is set in front of the passenger seat (in front of the passenger seat next to the driver's seat). Thus, when the vehicle display device is in anti-peeping mode, it is mainly for the passenger in the passenger seat to watch. When the vehicle display device is in the sharing mode, it can be shared with a driver in the driver's seat for watching due to the brightness being improved by the viewing angle between 0 degrees and −80 degrees. Although the second light source 170 in the embodiment is arranged next to the short edge of the second light-emitting surface 123, the second light source can be adjusted next to the long edge of the second light-emitting surface 123 according to a requirement.

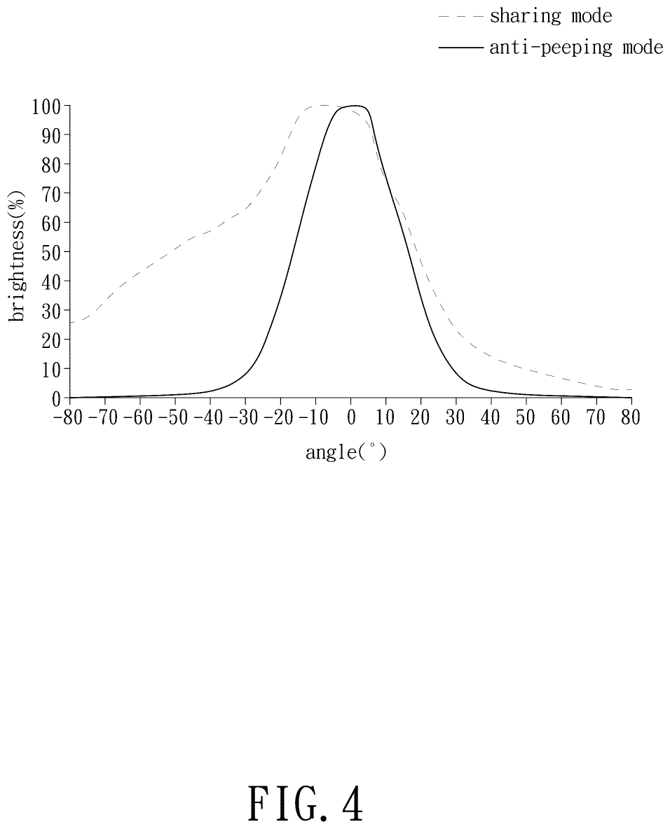

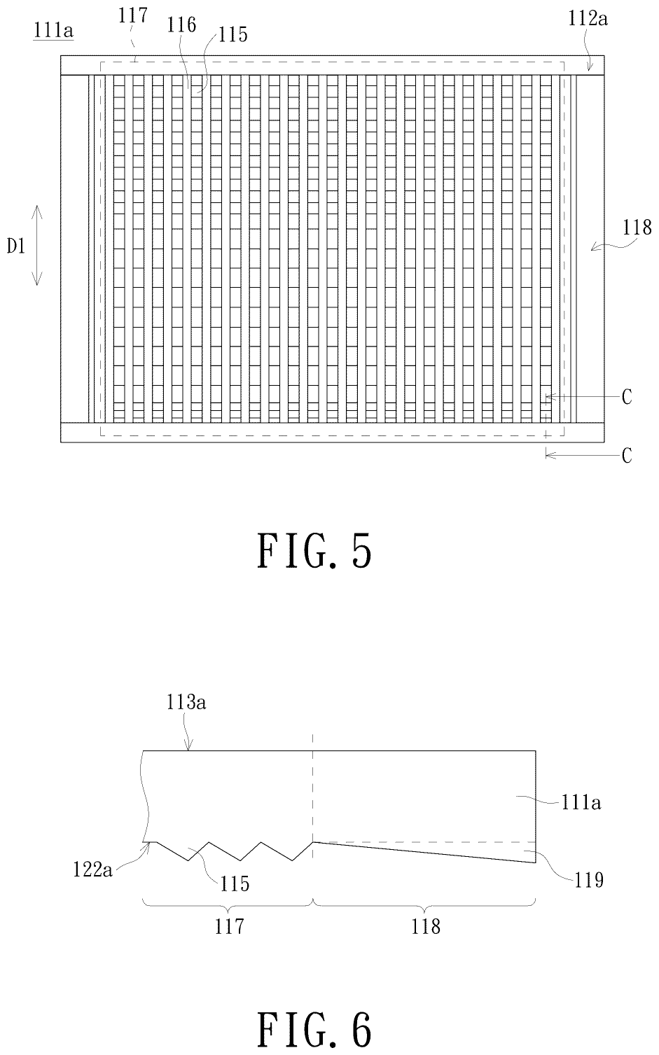

FIG. 5 is a schematic bottom diagram of a first light guide plate of a backlight module in another embodiment of the present invention. FIG. 6 is a cross-sectional diagram taken along the section C-C in FIG. 5. FIG. 5 is a schematic diagram when the first bottom surface 112a of the first light guide plate 111a faces upward, where the section C-C is, for example, parallel to the row direction D1. Referring to FIG. 5 and FIG. 6, in the embodiment, the first light guide plate 111a is similar to the first light guide plate 111. The major difference lies in that the first bottom surface 112a of the first light guide plate 111a further has, for example, a central area 117 and a peripheral banded area 118, and the peripheral banded area 118 at least partially encircles, for example, the central area 117. The central area 117 has, for example, a plurality of first microstructures 115 and a plurality of fourth microstructures 116 shown in FIG. 2, details of which are as described above. The peripheral banded area 118 has, for example, a plurality of third microstructures 119, and the third microstructures 119 are different from the first microstructures 115. Because the third microstructures 119 are different from the first microstructures 115, the third microstructures 119 can have a reflection with a large angular range and light directivity in different directions. The reflected light in the peripheral banded area 118 can be uniformly scattered, which contributes to reducing the light-harvesting problem of the corresponding first light-emitting surface 113a. In other words, the bright line or spray light problem of the first light-emitting surface 113a corresponding to the peripheral banded area 118 can be greatly reduced. The present invention has no specific limitations thereon.

In conclusion, the light guide assembly of the backlight module provided by the present invention uses the plurality of overlapped first light guide plates. The first light guide plates are thinner, which contributes to transmitting light rays in the first light guide plates to the first microstructures, so that the light rays are easily emitted from the first light-emitting surface, and therefore, the light utilization ratio can be improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module, comprising:
a light guide assembly, comprising a plurality of overlapped first light guide plates, where each of the first light guide plates has a first bottom surface, a first light-emitting surface, and a first light-incident surface, the first bottom surface and the first light-emitting surface are opposite to each other, the first light-incident surface is connected between the first bottom surface and the first light-emitting surface, and the first bottom surface is provided with a plurality of first microstructures;
a first light source, arranged next to the first light-incident surfaces of the first light guide plates;
a second light guide plate, arranged above the light guide assembly, wherein the second light guide plate has a second bottom surface, a second light-emitting surface, and a second light-incident surface, the second bottom surface and the second light-emitting surface are opposite to each other, the second light-incident surface is connected between the second bottom surface and the second light-emitting surface, and the second bottom surface faces the light guide assembly and is provided with a plurality of second microstructures;
a second light source, arranged next to the second light-incident surface of the second light guide plate;
a turning film, arranged between the light guide assembly and the second light guide plate; and
a reflective sheet, arranged on a side of the light guide assembly away from the second light guide plate.

2. The backlight module according to claim 1, further comprising an anti-peeping sheet, arranged between the second light guide plate and the turning film.

3. The backlight module according to claim 1, wherein the backlight module is in an anti-peeping mode when the first light source is turned on, and the backlight module is in a sharing mode when the first light source and the second light source are turned on.

4. The backlight module according to claim 1, wherein the first microstructures are prisms and are arranged in a plurality rows, a row direction of the rows is perpendicular to the first light-incident surface, an extension direction of each of the first microstructures is perpendicular to the row direction, and a quantity of the first microstructures in each of the rows is plural.

5. The backlight module according to claim 1, wherein there is an included angle between the first light-incident surface and the second light-incident surface.

6. The backlight module according to claim 5, wherein the first light-emitting surface and the second light-emitting surface of each of the first light guide plates are rectangular, the first light source faces a long edge of the first light-emitting surface of each of the first light guide plates, and the second light source faces a short edge of the second light-emitting surface.

7. The backlight module according to claim 1, wherein a thickness of each of the first light guide plates is less than a thickness of the second light guide plate.

8. The backlight module according to claim 1, wherein the plurality of second microstructures are micro-dot structures protruding from or sunken into the second bottom surface.

9. The backlight module according to claim 1, wherein the first light source comprises a plurality of first light-emitting elements, the second light source comprises a plurality of second light-emitting elements, each of the first light-emitting elements has a first length in a predetermined direction perpendicular to the first light-emitting surface, the light guide assembly has a second length in the predetermined direction, and the second length is greater than the first length.

10. The backlight module according to claim 1, wherein the first bottom surface of each of the first light guide plates has a central area and a peripheral banded area, the peripheral banded area at least partially encircles the central area, the central area has the plurality of first microstructures, the peripheral banded area has a plurality of third microstructures, and the third microstructures are different from the first microstructures.
